(19) United States
(12) Patent Application Publication
(10) Pub. No.: US 2004/0130140 A1
(43) Pub. Date: Jul. 8, 2004

(54) Map

(76) Inventor: Derek Dacey, Winford (GB)

Correspondence Address: Arthur G. Schaier, Carmody & Torrance LLP, 50 Leavenworth Street, P.O. Box 1110, Waterbury, CT, 06721-1110, US

(21) Appl. No.: 10/682,756

(22) Filed: Oct. 9, 2003

(30) Foreign Application Priority Data
Oct. 10, 2002 (GB) 0223507.5

(51) Int. Cl. G09B 29/00

(52) U.S. Cl. 283/34

(57) ABSTRACT

There is provided a map 10 in the form of a folded sheet of paper or paperboard. In the embodiment shown, the sheet is folded in concertina fashion about a number of parallel fold lines to define a number of panels 12 including a front panel 12a. A compass 13 provided in a plastic moulding 17 is secured at the top of the front panel 12a. The moulding 17 has a short flange at its topmost edge, which flange is generally perpendicular to the plane of the front panel 12a so as to extend over the top edges of the folded panels. The flange can be printed on its external surface for reference purposes.

The present invention relates to a map formed from a sheet of material adapted to be folded and unfolded.

According to a first aspect of the present invention, there is provided a map comprising a sheet of material adapted to be folded and unfolded between a predetermined folded configuration and a predetermined unfolded configuration, the sheet having at least one map drawing printed thereon and bearing a predetermined pattern of fold lines which determine the folded and unfolded configurations, a compass being secured to the sheet of material.

Ideally, the compass comprises a housing which has a spine portion in the form of a flange which is substantially perpendicular to the plane of the sheet material such that it extends around the edge of the sheet of material when in its folded configuration. It can be particularly advantageous when the spine portion has writing or other graphics printed thereon.

In preferred arrangements, the sheet of material is substantially rectangular and the pattern of fold lines comprises a number of spaced, parallel folds to define a number of panels in a series which are folded in concertina fashion. In addition, the map drawings are provided on both sides of the sheet of material and the compass is located so as to be readable in conjunction with the map drawings on both sides of the sheet.

Further preferred features are that the front side of the sheet, when facing up, has an extreme right hand panel with the compass mounted at the top edge of this panel, a first of the map drawings being printed on at least some of the panels to the left of this panel. Also the rear side of the sheet, when facing up, has the second of the map drawings printed on at least some of the panels to the right of the two left-most panels such that the extreme left panel can be folded over the adjacent panel to leave the compass adjacent the second of the map drawings.

Usually, information is printed in areas not covered by the map drawings and perhaps an information booklet is secured to the rear side of the panel to which the compass is attached.

Normally, the sheet material is one of the following: paper or paperboard or fabric and preferably the sheet material is laminated with protective film.

According to a second aspect of the present invention, there is provided a compass for attachment to a flat surface comprising a housing and a compass element mounted in the housing, the housing having a substantially flat undersurface, an upper surface in which the compass element is visible and an end flange extending substantially perpendicularly from the undersurface in a direction away from the upper surface.

An embodiment of the invention will now be described in more detail. The description makes reference to the following schematic drawings in which:

FIG. 1 is a front view of a folded map according to the present invention,

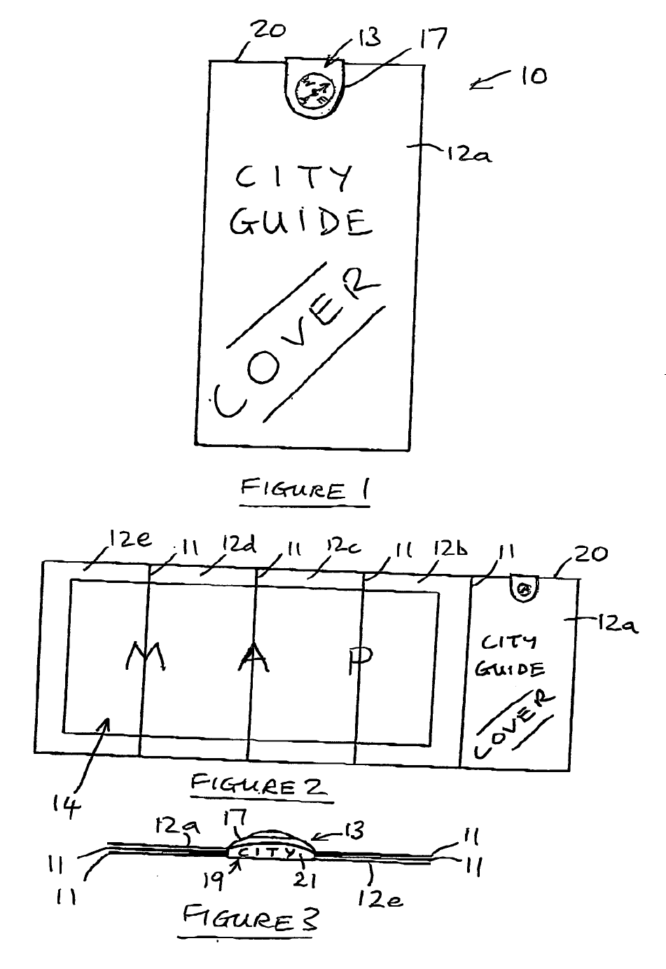

FIG. 2 is a front view of the FIG. 1 map in an unfolded configuration,

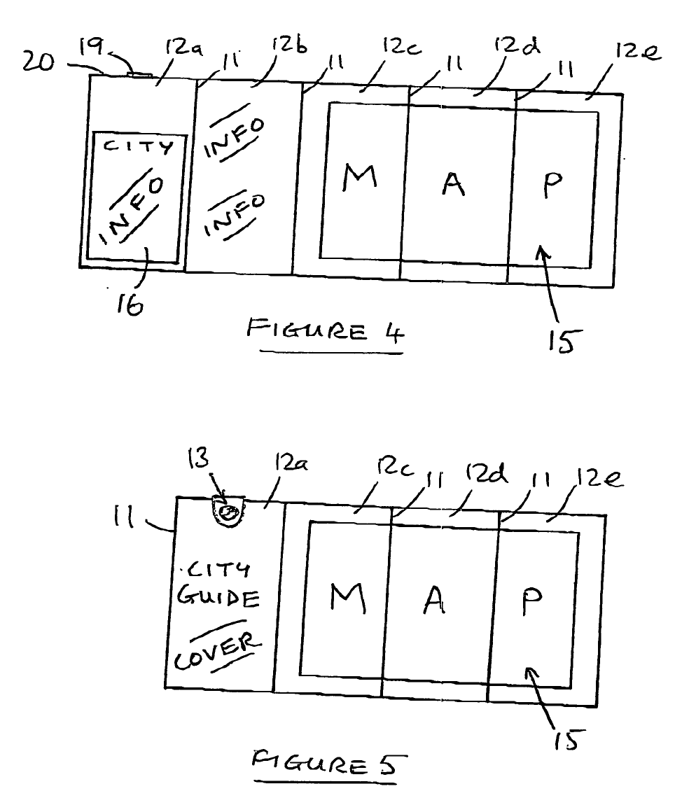

FIG. 3 is a rear view of the FIG. 2 arrangement,

FIG. 4 is a rear view of the FIG. 1 map with the cover folded back,

FIG. 5 is a top end view of the FIG. 1 map,

FIG. 6 is a plan view of the compass attached to the FIG. 1 map,

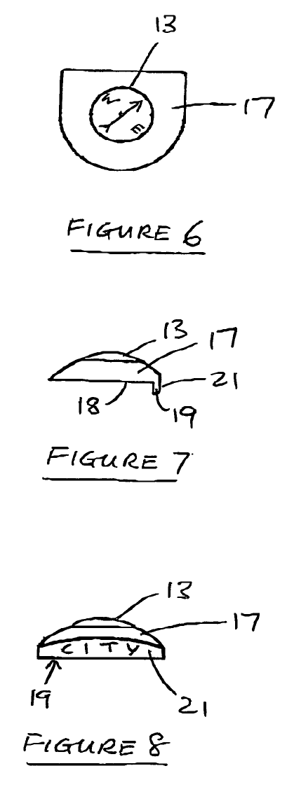

FIG. 7 is a side view of the FIG. 6 compass, and

FIG. 8 is a top end view of the FIG. 6 compass.

In the drawings, there is shown a map 10 which is particularly, but not exclusively, suited to being a tourist map, for a city for example, which is ideally small enough to be slipped into a pocket or a bag when not in use.

The map 10 is formed as a rectangular sheet of paperboard and is preformed with a number of parallel fold lines 11 to define a series of five panels 12a to 12e, although more or less panels could be provided. The fold lines 11 alternate between inward folds and outward folds such that the map 10 can be folded in concertina fashion. Other folding configurations could, however, be envisaged by the skilled person. A compass 13 is attached to the front face of panel 12a which in the illustrated embodiment is the extreme right hand panel as shown in FIG. 2. On the front side of the other panels 12b to 12e, a first map drawing 14 is printed and cover details are printed on the front face of panel 12a.

On the rear face of panels 12c to 12e, a second map drawing 15 is printed. Other information is printed on the rear face of panels 12a and 12b. The second map drawing 15 does not extend onto panel 12b so that panel 12a can be folded back over the rear face of panel 12b to leave the compass 13 clearly visible next to the second map drawing 15 as shown in FIG. 4.

A small booklet 16 containing various information is also attached to the rear face of panel 12a in the embodiment shown.

The compass 13 itself is provided in a plastic moulding 17 which has a flat underside 18 for attachment to the front face of panel 12a. The moulding 17 also has a flange 19 which projects at right angles to the underside 18. The flange 19 extends over the top edge 20 of the panel 12a and, indeed, over the top edge 20 of the other panels when the map 10 is in its folded configuration.

The moulding 17 therefore provides a housing for the compass 13, a suitable surface for attachment to the map and a flange 19 which provides some protection for the compass and for the edge 20 of the map and which locates against the top edge to correctly position the compass housing. The flange 19 also provides an outward facing surface 21 on which writing or other graphics can be printed. In the illustrated embodiment, the name of the city to which the maps relate is printed on the surface 21. This overcomes a problem with folded maps of this type because, when stacked on a shelf, it is not possible to identify the subject area covered by the map. With the above described arrangement, however, the printing on the surface 21 of the flange will be visible to identify the contents.

The illustrated moulding 17 and compass 13 has a smooth, rounded appearance which is not only aesthetically pleasing but also results in a product that is easier to handle. This is because sharp edges have been minimised such that there is much less likelihood of catching the compass on other products or items. In particular this can aid the stacking of the product by both the retailer and the consumer.

It would also be possible in an alternative arrangement to provide a small return flange at the end of the flange 19 remote from the flat underside 18 of the moulding 17. The panels of map 10 could then tuck behind the return flange so as to retain them in the folded condition.

The map 10 described above is made of paperboard but could also be made of paper or fabric or other foldable material. Ideally the map is laminated with a protective plastic film to resist damage.

The shape, size and location of the compass and its associated flange 19 could, of course, be varied whilst still having the advantageous effects described above.

1. A map comprising a sheet of material adapted to be folded and unfolded between a predetermined folded configuration and a predetermined unfolded configuration, the sheet having at least one map drawing printed thereon and bearing a predetermined pattern of fold lines which determine the folded and unfolded configurations, a compass being secured to the sheet of material.

2. A map as claimed in claim 1, wherein the compass comprises a housing which has a spine portion in the form of a flange which is substantially perpendicular to the plane of the sheet material such that it extends around the edge of the sheet of material when in its folded configuration.

3. A map as claimed in claim 2, wherein the spine portion has writing or other graphics printed thereon.

4. A map as claimed in any one of claims 1 to 3, wherein the sheet of material is substantially rectangular and the pattern of fold lines comprises a number of spaced, parallel folds to define a number of panels in a series which are folded in concertina fashion.

5. A map as claimed in claim 4, wherein the map drawings are provided on both sides of the sheet of material and the compass is located so as to be readable in conjunction with the map drawings on both sides of the sheet.

6. A map as claimed in claim 5, wherein the front side of the sheet, when facing up, has an extreme right hand panel with the compass mounted at the top edge of this panel, a first of the map drawings being printed on at least some of the panels to the left of this panel.

7. A map as claimed in claim 6, wherein the rear side of the sheet has the second of the map drawings, when facing up, printed on at least some of the panels to the right of the two left-most panels such that the extreme left panel can be folded over the adjacent panel to leave the compass adjacent the second of the map drawings.

8. A map as claimed in claim 6 or claim 7, wherein information is printed in areas not covered by map drawings.

9. A map as claimed in any one of claims 6 to 8, wherein an information booklet is secured to the rear side of the panel to which the compass is attached.

10. A map as claimed in any one of claims 1 to 9, wherein the sheet material is one of the following: paper or paperboard or fabric.

11. A map as claimed in claim 10, wherein the sheet material is laminated with protective film.

12. A compass for attachment to a flat surface comprising a housing and a compass element mounted in the housing, the housing having a substantially flat undersurface, an upper surface in which the compass element is visible and an end flange extending substantially perpendicularly from the undersurface in a direction away from the upper surface.
